(19) United States
(12) Patent Application Publication
(10) Pub. No.: US 2019/0281880 A1
(43) Pub. Date: Sep. 19, 2019

(54) MICROENCAPSULATED NON-STARCH POLYSACCHARIDES FOR DIET FOOD COMPOSITIONS

(71) Applicant: Chef Low Cal Foods Inc., Lethbridge (CA)

(72) Inventor: Hal Pio Chouinard, Lethbridge (CA)

(73) Assignee: Chef Low Cal Foods Inc., Lethbridge, AB (CA)

(21) Appl. No.: 16/348,006

(22) PCT Filed: Nov. 2, 2017
(86) PCT No.: PCT/CA2017/051303

§ 371 Date: May 7, 2019

Related U.S. Application Data
(60) Provisional application No. 62/503,407, filed on May 9, 2017.
(60) Provisional application No. 62/418,306, filed on Nov. 7, 2016.

(51) Int. Cl. A23P 10/30; A21D 13/06; A23L 29/219; A23L 33/26; A23L 33/24; A21D 2/18

(52) U.S. Cl. CPC A23P 10/30; A21D 13/06; A23L 29/219; A23L 33/26; A23L 33/24; A23V 2250/5118; A21D 2/188; A23V 2002/00; A23V 2200/126; A23V 2200/224; A23V 2250/5108; A21D 2/186

(57) ABSTRACT

Disclosed herein is a method for producing a microencapsulated non-starch polysaccharide substitute for flour. The method comprises: (i) dispersing a food-grade starch into a medium at a concentration from the range of about 2% to about 50% by weight to form a food-grade starch dispersion; (ii) mixing the food-grade starch dispersion with non-starch polysaccharide particles such that the food-grade starch microencapsulates the non-starch polysaccharide particles to form microencapsulated non-starch polysaccharide particles; and (iii) drying the microencapsulated non-starch polysaccharide particles. The microencapsulated non-starch polysaccharide particles may be used as a replacement (or a partial replacement) for flour to increase the fiber content while reducing the caloric availability of baked foodstuffs, pastas, and the like.

### TECHNICAL FIELD

This disclosure generally relates to foodstuffs with reduced caloric content and/or reduced-caloric availability. More specifically, this disclosure pertains to flour substitutes with reduced caloric content and/or reduced caloric availability.

### BACKGROUND

Obesity is a worldwide problem with recent estimates suggesting that roughly 500 million adults are obese, i.e., having a body mass index (BMI) of 30 or higher (Finucane et al., 2011, National, regional, and global trends in body-mass index since 1980: systematic analysis of health examination surveys and epidemiological studies with 960 country-years and 9.1 million participants. Lancet 377:557-67). The same report suggests that nearly 1.5 billion adults are overweight/obese, i.e., having a BMI of 25 of higher. About 69% of North American adults (roughly 2 in 3) are overweight/obese and about 1 out of 3 (39%) are considered obese with BMIs over 30.

Although the occurrence and severity of obesity may be affected by genetic, behavioral and hormonal influences on body weight, it is generally accepted that a regular in-take of more calories than are burned through exercise and normal daily activities is a primary cause of obesity. In short, combining a high-calorie diet with a sedentary lifestyle results in the storage of excess calories as fat. Thus, problems with obesity are exacerbated by over-consumption of high-calorie foods and beverages.

One strategy for combating and reducing obesity focuses on reducing caloric intake by incorporating reduced-calorie foods and/or beverages into diets. A related strategy involves reducing caloric uptake by incorporating foodstuffs with reduced caloric availability. However, both of these strategies are limited as applied to flour-based foodstuffs such as pastas, breads, buns, muffins, bagels, cookies, and the like. Flours are relatively calorie dense (e.g., grain-flours typically comprise about 350 kcal per 100 g), and attempts to provide flour substitutes with reduced caloric content and/or reduced caloric availability have not been successful on a commercial basis.

### SUMMARY

Some embodiments of the present disclosure relate to methods for producing a microencapsulated non-starch polysaccharide substitute for flour, the method comprising: (i) dispersing a food-grade starch into a medium at a concentration from the range of about 2% to about 50% by weight to form a food-grade starch dispersion; (ii) mixing the food-grade starch dispersion with non-starch polysaccharide particles such that the food-grade starch microencapsulates the non-starch polysaccharide particles to form microencapsulated non-starch polysaccharide particles; and (iii) drying the microencapsulated non-starch polysaccharide particles.

Some embodiments of the present disclosure relate to microencapsulated non-starch polysaccharide products produced with the methods disclosed herein. The microencapsulated non-starch polysaccharide products may be used as substitutes (or partial substitutes) for flour to reduce the caloric content and/or availability of baked foodstuffs, pastas, and the like.

### BRIEF DESCRIPTION OF THE FIGURES

The embodiments of the present disclosure will be described with reference to the following drawings in which:

FIG. 1 is a chart illustrating the particle size distribution of three forms (1, 2, and 3) of a microencapsulated non-starch polysaccharide (MNSP) prepared following a method according to an embodiment of the present disclosure;

FIG. 2 is a schematic illustration comprising a cut-away drawing of a microencapsulated particle 200 according to one embodiment of the present disclosure, wherein an outer layer 202 comprising starch encapsulates an inner core 204 of cellulose;

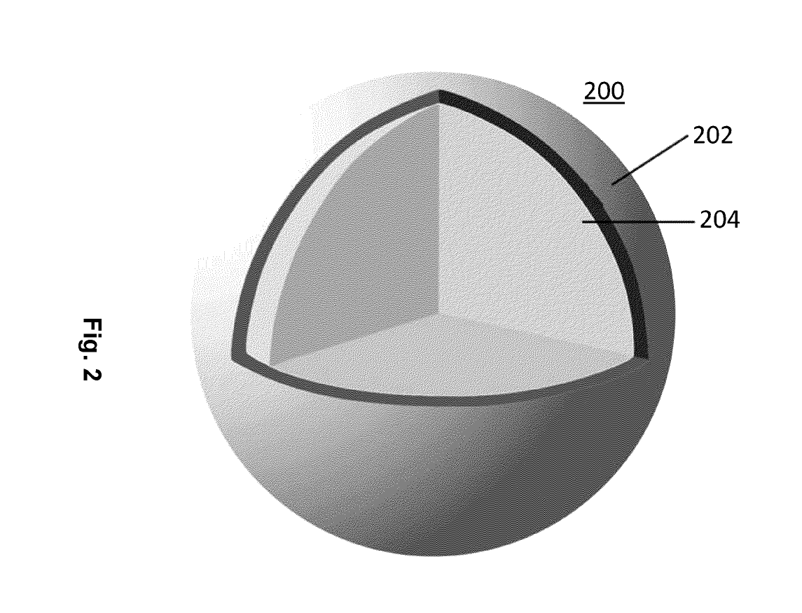

FIG. 3 is a schematic illustration of a dough mixture 300 produced by blending a flour 302 with microencapsulated non-starch polysaccharide particles 304 prepared following a method according to an embodiment of the present disclosure; and

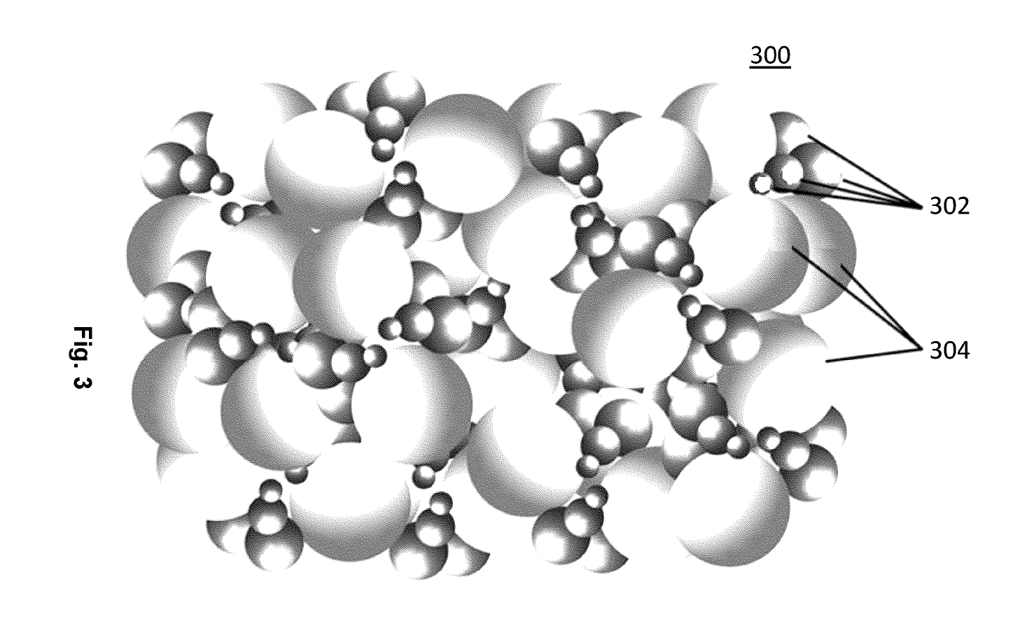

FIG. 4 is a bar chart showing taste test results for a series of reduced caloric content/availability foodstuffs with varying contents of microencapsulated non-starch polysaccharide particles prepared following a method according to an embodiment of the present disclosure.

### DETAILED DESCRIPTION

Some embodiments of the present disclosure generally relate to methods for microencapsulation with a food-grade starch, of a non-starch polysaccharide to produce a flour substitute. In some embodiments, the flour substitute may be incorporated into foodstuffs with reduced caloric content. As used herein, the term “reduced caloric content” means having a lower number of calories as compared to an equivalent which does not incorporate the flour substitute. In some embodiments, the flour substitute may be incorporated into foodstuffs with reduced caloric availability. As used herein, the term “reduced caloric availability” means having a higher content of a non-starch polysaccharide and a lower starch content as compared to an equivalent which does not incorporate the flour substitute. In some embodiments, the flour substitute may be a partial flour substitute. In the present disclosure, the term “partial flour substitute” is used in instances where the flour substitute replaces some, but not all, of the flour content of a foodstuff.

According to an embodiment of the present disclosure, a suitable non-starch polysaccharide particle may be a gel-forming fiber or a water-insoluble fiber. Examples of suitable gel-forming fibers include psyllium, chitin, guar gums, polydextrins, polyols, and the like. Suitable water-insoluble fibers include plant-derived cellulose fibers and chemically-derived cellulose fibers. Examples of suitable plant-derived cellulose fibers include cellulose fibers derived from cereal grains, legume seeds, fruits, vegetables, tubers (e.g. potatoes), roots, grasses, angiosperms, gymnosperm, and the like. Examples of suitable chemically-derived cellulose fibers include carboxymethyl cellulose, sodium carboxymethyl cellulose, and the like.

According to another embodiment of the present disclosure, a suitable food-grade starch may be a potato starch, a wheat starch, a corn starch, a rice starch, a cassava starch, or the like. The food-grade starch may be processed prior to use in the present methods to further reduce the mesh size of the starch prior to mixing the starch with the core particles to facilitate uniform density and distributed microencapsulation of the core particles in order to provide tailorable taste, silky tactile characteristics, and aromas.

An example of one embodiment of the present disclosure comprises dispersing non-starch polysaccharide particles (also referred to herein as “core” particles) into an aqueous phase to form a first dispersion, dispersing a food-grade starch in an aqueous phase to form a second dispersion, and mixing the first dispersion and the second dispersion whereby the core particles are microencapsulated with the starch thereby forming a MNSP. According to another embodiment of the present disclosure, the MNSP produced as disclosed herein, may be used to replace a portion of conventional flours used to prepare baked foodstuffs, doughs, pastas, and animal nutritional products. Incorporation of the MNSP into such products can be made at a ratio of MNSP to flour of 5:95, 10:90, 15:85, 20:80, 25:75, 30:70, 35:65, 40:60, 45:55, 50:50, 55:45, 60:40, 65:35, 70:30, 75:25, 80:20, and therebetween.

In some embodiments, the method for producing the MNSP substitute for flour involves the following manufacturing steps:
1. Optionally pre-processing the starch by existing technological means such as extrusion, heating, ultrasonics, microfluidization, or high-pressure processing. The starch may be selected to approximate the desired characteristics of the related conventional flour(s) in the final food product.
2. Dispersing the starch in an aqueous phase. The starch may be incorporated at a concentration from the range of about 2% to about 50% by weight.
3. Mixing the non-starch polysaccharide particles with the starch dispersion and homogenizing the mixture to obtain a mixture where the non-starch polysaccharide particles are fully surrounded by the starch with an average size typically in the range of about 20 microns to about 700 microns.
4. Drying the microencapsulated non-starch polysaccharide particles, optionally by spray-drying, to provide a powdered formulation. Other options for providing the powdered formulation include physical methods such as air-suspension coating, centrifugal extrusion, pan coating, and vibrating nozzle; physico-chemical methods such as coacervation and ionotropic gelation; and chemical methods such as in-situ polymerization, interfacial cross-linking, interfacial polycondensation, and matrix polymerization.

The procedures for the preparation of dough comprising the MNSP disclosed herein may incorporate/blending dry MNSP forms, or alternatively, the MNSP may be hydrated prior to incorporation into dough mixtures. In the pre-hydration variant, the dry particle is hydrated with water at a ratio of particle/water ranging but not limited to from 1:1 to 1:8 and left to hydrate at room temperature and pressure from 1 to 45 minutes. The particle characteristics have demonstrated optimal results with the pre-hydration option at 1:4 ratio with a hydration rest time of 30 minutes.

In some embodiments, the dough comprising the MNSP disclosed herein may be a cookie dough, a cake dough, a pie dough, a tart dough, a pastry dough, a puff pastry dough, a croissant dough, a phyllo dough, a bread dough, a pasta dough, or the like.

In some embodiments, the dough may be coloured by a food-grade colourant such as allura red, amaranth, annatto, anthocyanins, 8′-carotenal, brilliant blue FCF, canthaxanthin, caramel, carotene, chlorophyll, cochineal, erythrosine, fast green FCF, gold, indigotine, iron oxide, lycopene extract, paprika, ponceau SX, riboflavin, silver metal, sodium copper chlorophyllin, sunset yellow FCF, tartrazine, titanium dioxide, turmeric, or the like.

### EXAMPLES

### Example 1

The following procedure was used to prepare a 90-g sample of a food-grade cellulose into which was blended 10 g of corn starch.
1. Prepare: (i) a 15%-16% cellulose dispersion in water and a 7% corn starch dispersion in water.
2. Slowly add the corn starch dispersion to the cellulose dispersion while mixing at room temperature.
3. Then, heat the mixture at 80° C.-85° C. for 30 mins while continuing mixing.
4. Homogenize/blend the mixture for 2-4 mins. Check the mixture after the blending step to confirm that it shows a gelling behavior.
5. Spray dry the mixture using an inlet temperature of 150° C. and an outlet temperature in the range of 85° C.-90° C. The output from the spray drier was a fine powder with a moisture content (MC) of less than 2%.

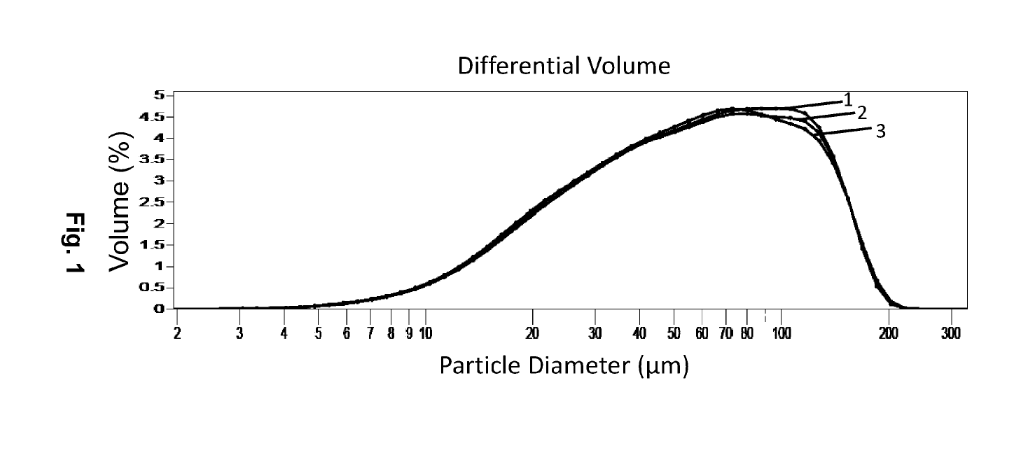

After drying, the encapsulated MNSP was analysed for its particle size distribution and for its fiber content. The MNSP particle sizes ranged from about 4.5 μ to about 200 μ with an average size of about 65.5 μ (FIG. 1). The dietary fiber analysis of the MNSP product is shown in Table 1.

TABLE 1

| | |
|---|---|
| Insoluble dietary fiber | 87.3% |
| Soluble dietary fiber | 2.5% |
| Total dietary fiber | 89.8% |

### Example 2

Three formulations of MNSP were prepared in a dispersion and then dried in a pilot facility with a propane-fired cyclone equipped with a blow-down recovery bag. The drying parameters and operating conditions are shown in Table 2.
Form#1 comprised 10:90 starch/cellulose (4.64 lb).
Form#2 comprised 7:93 starch/cellulose (6.62 lb).
Form#3 comprised 5:95 starch/cellulose (5.73 lb).

The recoveries of dried MNSP were:
(i) Form#1 MNSP 4.08 lb (87.9%),
(ii) Form#2 MNSP 5.62 lb (87.9%), and
(iii) Form #3 MNSP 5.2 lb (90.7%) (Table 2).

Differential volumes for Form #1, 2, and 3 are shown in FIG. 1.

TABLE 2

| | | Run #: | | |
|---|---|---|---|---|
| | | 1 | 2 | 3 |
| | | Product/Formulation/-Lot #: | | |
| | | 10/90 | 7/93 | 5/95 |
| Main Run Objectives: To . . . | | | | |
| Initial Test Run/Determine Settings/Dryability: | | yes | no | no |
| Determine/Change/Confirm Formulation: | | yes | no | yes |
| Optimization Run: (Optimize Run Conditions): | | yes | no | no |
| Achieve Required Moisture Content: | | yes | yes | yes |
| Production Run: | | no | no | no |
| Dryer Setup: | Heat Release, Btu/hr. | 105.500 | 103.100 | 104.500 |
| | Fuel Valve. % | 45% | 45% | 45% |
| | Rotameter, Btu/hr. | | | |
| | Contact Temp., F. | 408 | 430 | 414 |
| | Electric Set point. F. | n/a | n/a | n/a |
| | Electric Coil Temp. F. | n/a | n/a | n/a |
| | Electric Setting. % | n/a | n/a | n/a |
| | Transport Air Temp. F. | n/a | n/a | n/a |
| | Outside Temp.. F. | 88 | 98 | 96 |
| | Exit Temp., F. | 180 | 180 | 180 |
| | Dew Point. F. | 48 | 46 | 45 |
| | Baghouse DP. (″ of H2O) | 5.00 | 4.75 | 5.24 |
| | Exhaust air Amp Ratio | 88.6 | 88.6 | 91.6 |
| | Turbo Air. psi | 85 | 85 | 85 |
| Air Set points: | Exhaust Air Set point (%) | 80% | 80% | 80% |
| | Comb. Air Set point (%) | 70% | 70% | 70% |
| | Quench Air Set point (%) | 70% | 70% | 70% |
| | Trans Air Set point (%) | 60% | 60% | 60% |
| Airflows (CFM): | Exhaust Airflow (CFM) | 512 | 512 | 512 |
| | Comb. Airflow (CFM) | 140 | 138 | 147 |
| | Quench Airflow (CFM) | 98 | 97 | 97 |
| | Trans Airflow (CFM) | n/a | n/a | n/a |
| Feed Pump: | Feed Pump (%) | 15.3% | 20.6% | 25.6% |
| Air Pressures: | Combustion Air Pressure | 2.92 | 2.89 | 2.81 |
| | Quench Air Pressure | 2.38 | 2.37 | 2.29 |
| | Combustor Can Pressure | 3.38 | 2.72 | 2.79 |
| | Venturi Pressure | 1.17 | 1.19 | 1.09 |
| | Vessel Pressure | −0.5 | −0.5 | −0.5 |
| System Efficiency: | Evaporative Rate. pph | 64.09 | 75.96 | 90.35 |
| | Efficiency. Propane. Btu/# H2O | 1.646 | 1.357 | 1.157 |
| | Trans Air Heating. Btu/hr. | | | |
| | Total Btu/hr. | 105.500 | 103.100 | 104.500 |
| | Btu/# H2O | 1.646 | 1.357 | 1.157 |
| | Btu/#H2O based on actual run time: | — | 1 | 2 |
| Characteristics: | Solids content in Feed. %: | 16.00% | 21.64% | 17.21% |
| | Product Temp. | 175.0 | 175.0 | 175.0 |
| | pH: | 5.7 | 5.7 | 5.7 |
| Run periods: | Start Time | 10:51 | 12:39 | 14:49 |
| | End Time | 11:18 | 13:03 | 15:11 |
| | Run Time | 0:27 | 0:24 | 0:22 |
| Feed Rate: | Feed Starting Weight. lb. | 31.50 | 31.80 | 33.30 |
| | Feed Ending Weight. lb. | 2.50 | 1.20 | |
| | Net Feed During Run. lb. | 29.00 | 30.60 | 33.30 |
| | Dry Solids Fed During Run. lb. | 4.64 | 6.62 | 5.73 |
| Recovered Material: | | | | |
| Recovery (Lbs.): | Cyclone Recovery. lb. | 3.00 | 3.26 | 3.10 |
| | Blowdown Recovery. lb. | 1.08 | 2.36 | 2.10 |
| | Total recovery. Lb. | 4.08 | 5.62 | 5.20 |
| Recovery (Yield %): | Cyclone Yield. % | 64.7% | 49.2% | 54.1% |
| | Blowdown Yield. % | 23.3% | 35.6% | 36.6% |
| | Total Yield. % | 87.9% | 84.9% | 90.7% |

### Example 3

One large batch of MNSP (26.6 lb) was prepared in a dispersion at a ratio of 7:93 starch/cellulose and then dried in a pilot facility with a propane-fired cyclone equipped with a blow-down recovery bag. The drying parameters and operating conditions are shown in Table 3. The large batch was split into four sub-batches that were dried separately, and then the collected dried fractions were pooled together. The total dried MNSP recovered was 21.2 lb (79.5%) with a MC of about 2.7%.

TABLE 3

| | | Run #: | | | | |
|---|---|---|---|---|---|---|
| | | 4-bucket 1 | 4-bucket 2 | 4-bucket 3 | 4-bucket 4 | 4-bucket 5 |
| | | Product/Formulation/-Lot #: | | | | |
| | | 7/93 | 7/93 | 7/93 | 7/93 | 7/93 |
| Main Run Objectives: To . . . | | | | | | |
| Initial Test Run/Determine Settings/Dryability: | | yes | yes | no | no | no |
| Determine/Change/Confirm Formulation: | | no | no | no | no | no |
| Optimization Run: (Optimize Run Conditions): | | yes | yes | no | no | no |
| Achieve Required Moisture Content: | | yes | yes | no | no | no |
| Production Run: | | yes | yes | yes | yes | yes |
| Dryer Setup: | Heat Release, Btu/hr. | 104.600 | 103.700 | 105.100 | 105.300 | 105.500 |
| | Fuel Valve. % | 45% | 45% | 45% | 45% | 45% |
| | Rotameter, Btu/hr. | | | | | |
| | Contact Temp., F. | 421 | 406 | 417 | 425 | 432 |
| | Electric Set point. F. | n/a | n/a | n/a | n/a | n/a |
| | Electric Coil Temp. F. | n/a | n/a | n/a | n/a | n/a |
| | Electric Setting. % | n/a | n/a | n/a | n/a | n/a |
| | Transport Air Temp. F. | n/a | n/a | n/a | n/a | n/a |
| | Outside Temp.. F. | 83 | 88 | 93 | 90 | 92 |
| | Exit Temp., F. | 180 | 190 | 190 | 190 | 190 |
| | Dew Point. F. | 54 | 54 | 54 | 54 | 52 |
| | Baghouse DP. (″ of H2O) | 5.52 | 4.77 | 5.01 | 5.23 | 5.39 |
| | Exhaust air Amp Ratio | 93.1 | 87.1 | 85.6 | 84.2 | 82.7 |
| | Turbo Air. psi | 85 | 85 | 85 | 85 | 85 |
| Air Set points: | Exhaust Air Set point (%) | 80% | 80% | 80% | 80% | 80% |
| | Comb. Air Set point (%) | 75% | 75% | 75% | 75% | 75% |
| | Quench Air Set point (%) | 75% | 75% | 75% | 75% | 75% |
| | Trans Air Set point (%) | 60% | 60% | 60% | 60% | 60% |
| Airflows (CFM): | Exhaust Airflow (CFM) | 512 | 512 | 512 | 512 | 512 |
| | Comb. Airflow (CFM) | 161 | 153 | 149 | 149 | 148 |
| | Quench Airflow (CFM) | 106 | 104 | 103 | 104 | 104 |
| | Trans Airflow (CFM) | n/a | n/a | n/a | n/a | n/a |
| Feed Pump: | Feed Pump (%) | 15.1% | 16.6% | 18.8% | 20.6% | 21.7% |
| Air Pressures: | Combustion Air Pressure | 3.16 | 3.26 | 3.24 | 3.25 | 3.20 |
| | Quench Air Pressure | 2.59 | 2.65 | 2.69 | 2.70 | 2.70 |
| | Combustor Can Pressure | 3.84 | 3.12 | 3.47 | 3.88 | 2.77 |
| | Venturi Pressure | 1.17 | 1.23 | 1.24 | 1.21 | 3.00 |
| | Vessel Pressure | −0.5 | −0.5 | −0.5 | −0.5 | −0.5 |
| System Efficiency: | Evaporative Rate. pph | 56.25 | 72.09 | 79.78 | 88.33 | 81.31 |
| | Efficiency. Propane. Btu/# H2O | 1.860 | 1.439 | 1.317 | 1.192 | 1.297 |
| | Trans Air Heating. Btu/hr. | | | | | |
| | Total Btu/hr. | 104.600 | 103.700 | 105.100 | 105.300 | 105.500 |
| | Btu/# H2O | 1.860 | 1.439 | 1.317 | 1.192 | 1.297 |
| | Btu/#H2O based on actual run time: | 3 | 4 | 5 | 6 | 7 |
| Characteristics: | Solids content in Feed. %: | 15.27% | 15.98% | 15.63% | 15.91% | 16.01% |
| | Product Temp. | 175.0 | 175.0 | 175.0 | 175.0 | 175.0 |
| | pH: | 5.7 | 5.7 | 5.7 | 5.7 | 5.7 |
| Run periods: | Start Time | 8:50 | 10:00 | 11:00 | 11:50 | 13:14 |
| | End Time | 9:26 | 10:28 | 11:25 | 12:13 | 13:39 |
| | Run Time | 0:36 | 0:28 | 0:25 | 0:23 | 0:25 |
| Feed Rate: | Feed Starting Weight. lb. | 33.90 | 33.80 | 33.40 | 34.02 | 34.04 |
| | Feed Ending Weight. lb. | — | — | — | — | — |
| | Net Feed During Run. lb. | 33.90 | 33.80 | 33.40 | 34.02 | 34.04 |
| | Dry Solids Fed During Run. lb. | 5.18 | 5.40 | 5.22 | 5.41 | 5.45 |
| Recovered Material: | | | | | | |
| Recovery (Lbs.): | Cyclone Recovery. lb. | | | | | 14.20 |
| | Blowdown Recovery. lb. | | | | | 7.00 |
| | Total recovery. Lb. | — | — | — | — | 21.20 |
| Recovery (Yield %): | Cyclone Yield. % | | | | | 53.3% |
| | Blowdown Yield. % | | | | | 26.3% |
| | Total Yield. % | | | | | 79.5% |

### Example 4

A reduced-calorie cookie (75% calorie) was prepared using the MNSP of Example 3 as a substitute for flour. In a first bowl, 112 g of butter, one large egg, 25 g of SPLENDA® (SPENDA is a registered trademark of Heartland Consumer Products LLC, Carmel, Ind., USA), and 3 g of vanilla extract were combined and creamed with a stand mixer to provide a first mixture. In a second bowl, 60 g of water and 15 g of the MNSP of Example 3 were combined and mixed to provide a second mixture. In a third bowl, 34 g of all-purpose flour, 3 g of cornstarch, 1.5 g of baking powder, and 1.5 g of salt were combined and mixed to provide a third mixture. A cookie dough was prepared by adding 34 g of the first mixture and 22 g of the second mixture to the third mixture. The dough was kneaded, portioned, and baked to provide reduced-calorie cookies.

### Example 5

A taste test comparison was conducted (survey size of nine) wherein participants rated three foodstuffs based on standard metrics such as appearance, flavour, texture, color, firmness, etc. Each of the three foodstuffs was prepared in four variants as follows:
Cookie 100% calories
Cookie 75% calories
Cookie 50% calories
Cookie 30% calories
Scone 100% calories
Scone 75% calories
Scone 50% calories
Scone 30% calories
Pasta 100% calories
Pasta 75% calories
Pasta 50% calories
Pasta 30% calories

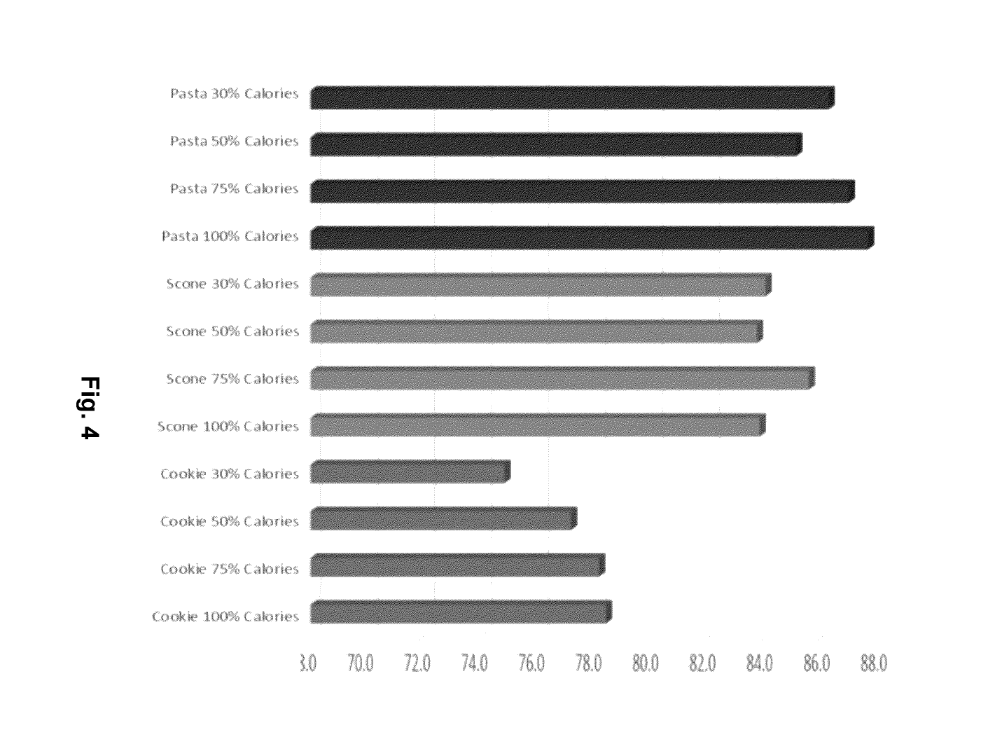

The reduced-caloric content foodstuffs (i.e. those with less than 100% calories) were prepared using the MNSP of Example 3 as a partial substitute for flour following procedures analogous to that of Example 4. In some instances, an additional step of colouring at least a part of some of the doughs with a food-grade colourant was completed. The results for each variant were converted to an overall score as shown in FIG. 4. For each of the pasta, the scone, and the cookie, the differences between the scores of each of the variants are minimal, and the results indicate no significant differences in overall enjoyment amongst the variants.

1. A method for producing a microencapsulated non-starch polysaccharide substitute for flour, the method comprising:
(i) dispersing a food-grade starch into a medium at a concentration from the range of about 2% to about 50% by weight to form a food-grade starch dispersion;
(ii) mixing the food-grade starch dispersion with non-starch polysaccharide particles such that the food-grade starch microencapsulates the non-starch polysaccharide particles to form microencapsulated non-starch polysaccharide particles; and
(iii) drying the microencapsulated non-starch polysaccharide particles.

2. The method of claim 1, wherein the food-grade starch is a pre-processed starch.

3. The method of claim 1, wherein the food-grade starch is a potato starch, a wheat starch, a corn starch, a rice starch, or a cassava starch.

4. The method of claim 1, wherein the non-starch polysaccharide particles are psyllium particles, chitin particles, guar gum particles, polydextrin particles, polyol particles, cellulose particles, or chemically-derived cellulose particles.

5. The method of claim 1, wherein the food-grade starch is a corn starch and the non-starch polysaccharide particles are cellulose particles.

6. The method of claim 1, wherein the food-grade starch is a potato starch and the non-starch polysaccharide particles are potato fiber particles.

7. The method of claim 1, wherein the medium is an aqueous medium.

8. The method of claim 1, wherein the concentration of the food-grade starch in the medium is from the range of about 10% to about 20% by weight.

9. The method of claim 1, wherein the microencapsulated non-starch polysaccharide particles have an average size in the range of about 20 microns to about 700 microns.

10. The method of claim 1, wherein the drying is spray drying.

11. A microencapsulated non-starch polysaccharide particle produced according to the method of claim 1.

12. Use of the microencapsulated non-starch polysaccharide particle according to claim 11, as a substitute for flour.

13. Use of the microencapsulated non-starch polysaccharide particle according to claim 11, as a partial substitute for flour.

14. Use of the microencapsulated non-starch polysaccharide particle according to claim 11, in a foodstuff having a reduced caloric content.

15. Use of the microencapsulated non-starch polysaccharide particle according to claim 11, in a foodstuff having a reduced caloric availability.

16. Use of the microencapsulated non-starch polysaccharide particle according to claim 11, in a foodstuff having a reduced caloric content and a reduced caloric availability.

17. The use of claim 12, wherein the microencapsulated non-starch polysaccharide particle is incorporated into a dough mixture in a pre-hydrated form.

18. The use of claim 12, wherein the microencapsulated non-starch polysaccharide particle is incorporated into a dough mixture in a dry form.

19. The use of claim 17, wherein the dough mixture is coloured with a food colourant.

20. The use of claim 16, wherein the dough mixture is a cookie dough mixture, a cake dough mixture, a pie dough mixture, a tart dough mixture, a pastry dough mixture, a puff pastry dough mixture, a croissant dough mixture, a phyllo dough mixture, a bread dough mixture, or a pasta dough mixture.
